(19) United States
(12) Patent Application Publication
(10) Pub. No.: US 2006/0122318 A1
(43) Pub. Date: Jun. 8, 2006

(54) Food-release packaging

(76) Inventors: Chang H. Jho, North Salem, NY (US); Istvan Borsody, Yonkers, NY (US); Tamal Ghosh, Ennetbaden (CH)

Correspondence Address: JoAnn Villamizar, Patent Department;Ciba Specialty Chemicals Corporation, 540 White Plains Road, P.O. Box 2005, Tarrytown, NY, 10591-9005, US

(21) Appl. No.: 11/273,643

(22) Filed: Nov. 14, 2005

Related U.S. Application Data
(60) Provisional application No. 60/629,026, filed on Nov. 18, 2004.
(60) Provisional application No. 60/714,809, filed on Sep. 7, 2005.

(51) Int. Cl. D21H 11/00; D21H 23/00; C09D 5/02

(52) U.S. Cl. 524/501; 162/135; 162/168.1

(57) ABSTRACT

The invention is directed to hot moist food packaging, a method for packaging the same, and a method to impart oil and grease repellency to paper or paperboard. The compositions and methods are especially valuable when used for packaging foods such as hot moist breads, buns and oily starchy foods such as potatoes. The compositions and method ensure that the paper in contact with the food does not stick to the bread bun or starchy foods and cause breaking or fragmentation.

This application claims the benefit of Provisional Application Nos. 60/629,026, file Nov. 18, 2004 and 60/714,809, filed Sep. 7, 2005.

### BACKGROUND OF THE INVENTION

The invention relates to paperboard or paper packaging coated with aqueous polymer emulsions with food-release properties and oil and grease repellency.

Paper-based clamshell packages designed for the delivery of fast foods, such as hamburgers and fish sandwiches are conventionally extrusion coated or laminated with polymers such as polyethylene or other thermoplastic material. The plastic acts as a water, oil/grease, and moisture barrier and provides a smooth surface so that the moist food product is released intact and less likely to stick to the paper. These barrier and release properties are necessary to maintain the integrity of the packaging and ultimately the integrity of the packaged food item in such a way that the food keeps the optimum form for presentation to the customer. Water vapor transmission barrier (WVTB) is also important in these packaging applications. The retention of the water vapor released from the food needs to be retained within the package in order to keep the food hot.

Oil and grease repellent (OGR) barrier properties are also necessary because of the oil and grease contained in the food, e.g. french fries, hamburger patty and condiments. Fluorochemicals have been used in the past as a benchmark coating for OGR properties. Although fluorochemicals are an excellent OGR barrier, they are not effective as a release coating when the food items such as a bun or bread is steamed instead of toasted before packaging. Steamed buns or breads such as warm moist breads, buns, wraps, pocket breads and fried potatoes such as french fries tend to stick to the packaging paper or paperboard thereby losing their integrity. The soft bread or bun surfaces of microwaved sandwiches, wraps and pocket breads also have a tendency to stick to paper or paperboard packaging. Polylaminated paper or paperboard are not an ideal solution since the cooling bun/ food generates a vapor which condenses onto the laminate surface and causes the bun or food to become soggy and stick to the laminate thus tearing the bun.

There have been numerous attempts to solve the above problem. U.S. Pat. No. 4,653,685 has attempted to solve the problem by providing a plurality of serrations formed on an inner surface of the container to resist sticking of contained food portions.

U.S. Pat. No. 5,131,551 describes a tray having a series of generally concentric formed ridges to inhibit sticking of the food product to the base.

U.S. Pat. No. 5,039,003 preferably coats a paper with polyethylene or other thermoplastic material providing a smooth surface so that food product does not stick to the food when the food is pulled out or unwrapped for consumption.

The coating of paper or paperboard with styrene-acrylate copolymers is known in the literature. See for example Michelman, J. S. et al, TAPPI J., April, pages 159-163 (1989) and U.S. Pat. No. 5,763,100. Styrene-acrylate copolymers are described as having good water resistance. Also see Cooper, R., Paper Technology, (1990), 31(4), 34-36 which describes styrene-acrylate polymer emulsions as barrier coatings.

It has surprisingly been discovered that both OGR and food-release requirements of the package can be met with particular non-fluorochemical water-based emulsions of styrene-acrylate copolymers. Thus the styrene-acrylate copolymers of the invention may be used for preventing sticking of hot moist foods, especially warm, moist breads to the paper or paper-board used for wrapping or enclosing these foods. These styrene-acrylate barrier coatings can be used alone, with an emulsifying polymer and optionally other additives such as—starches, fluorochemicals, waxes or mixtures thereof to enhance other barrier properties.

This invention can be expanded to other paper-based packaging grades, such as food wraps, takeout containers for ready prepared foods, where not only OGR barrier and/or WVTB is required but also non-sticking characteristics of the package toward hot moist foods are desired.

### SUMMARY OF THE INVENTION

The invention encompasses a hot moist food packaging
wherein the packaging is a paper or paperboard coated with a coating composition and the coating comprises a
a water based emulsion polymer, wherein the polymer comprises
   i) a copolymer formed from a (meth)acrylate monomer or monomers and a vinyl monomer or monomers to give a film-forming copolymer,
wherein the film-forming polymer is formed in the presence of a stabilizing polymer, wherein the stabilizing polymer is an acid-containing copolymer formed by copolymerizing a (meth)acrylic acid monomer or a mixture of (meth)acrylic acid monomers, and a vinyl monomer or mixture of vinyl monomers other than the (meth) acrylic acid monomer,
   and
   ii) optionally, other additives or mixtures of additives,
      wherein, the coated paper or paperboard has a bun-release rating of no more than about 3.

Preferable the bun-release rating is no more than about 2, especially less than 2, for example 1. The bun-release test is described herein.

The invention encompasses a method to impart oil and grease resistance to paper or paperboard, which comprises treating the paper or paperboard material with an effective amount of a coating composition comprising a

water based emulsion polymer, wherein the polymer comprises
i) a copolymer formed from a (meth)acrylate monomer or monomers and a vinyl monomer or monomers to give a film-forming copolymer,
   wherein the film-forming polymer is formed in the presence of a stabilizing polymer,
   wherein the stabilizing polymer is an acid-containing copolymer formed by copolymerizing a (meth)acrylic acid monomer or a mixture of (meth)acrylic acid monomers, and a vinyl monomer or mixture of vinyl monomers other than the (meth) acrylic acid monomer,
and
ii) optionally, other additives or mixtures of additives,
   wherein the coating composition is effective in imparting oil and grease resistance to the paper or paperboard material.

Preferably the emulsion polymer is in the form of a core-shell particle emulsion.

Another embodiment of the invention is a method for packaging hot moist foods comprising the steps of
a) coating a paper or paper-board container or wrapper with a coating composition comprising
   a water based emulsion polymer comprising
      i) a copolymer formed from a (meth)acrylate monomer or monomers and a vinyl monomer or monomers to give a film-forming copolymer,
   and
      ii) optionally, other additives or mixtures of additives,
b) drying the coating
and
c) contacting the hot moist food with the coated paper or paperboard container or wrapper,
   wherein the food may be heated in the coated paper or paperboard or alternatively the food may be heated then wrapped in the coated paper or paperboard.

The invention also embodies a method of releasing hot moist food from the surface of paper or paperboard, wherein the method of releasing the hot moist food comprises the steps of
a) coating a paper or paperboard with a coating composition comprising
   a water based emulsion polymer, wherein the polymer comprises
      i) a copolymer formed from a (meth)acrylate monomer or monomers and a vinyl monomer or monomers to give a film-forming copolymer,
      and
      ii) optionally, other additives or mixtures of additives,
b) drying the coating,
c) contacting the coated paper or paperboard with the food
and
d) removing the coated paper or paperboard from contact with the said food.

A third embodiment of the invention is a method for packaging hot moist foods in paper or paperboard and maintaining the temperature of these food items during delivery wherein the method of packaging and maintaining the temperature of the food comprises the steps of
a) coating a paper or paperboard with a coating composition
   a water based emulsion polymer comprising
      i.) a copolymer formed from a (meth)acrylate monomer or monomers and vinyl monomer or monomers to give a film-forming copolymer,
   and
      ii) optionally, other additives or mixtures of additives,
b) drying the coating
and
c) wrapping or enclosing the hot moist food with the coated paper or paperboard container or wrapper,
wherein the food may be heated in the coated paper or paperboard or alternatively, the food may be heated then wrapped or enclosed in the coated paper or paperboard.

Another embodiment of the methods above further include the film-forming polymer being polymerized in the presence of an stabilizing polymer, wherein the stabilizing polymer is an acid-containing copolymer formed by copolymerizing (meth)acrylic acid monomer, and a vinyl monomer other than the (meth)acrylic acid monomer. Thus the water-based emulsion polymer comprises both the film-forming copolymer and a stabilizing polymer.

In the methods described above the food may be heated first then placed in contact with the paper or paperboard. Alternatively, the food may be heated within or on the paper or paperboard. The end result is the hot moist food does not stick to the paper when an attempt is made to unwrap the food.

The methods and coated paper or coated paperboard composition described above are especially valuable when used for packaging foods such as hot moist breads, buns or potatoes ensuring that paper used in wrapping hot moist foods or microwaved foods do not stick to the food and cause breakage and fragmentation.

### DETAILED DESCRIPTION OF THE INVENTION

The present invention provides a coated paper or paperboard for packaging hot moist foods, a method for packaging hot moist foods, a method for releasing hot moist foods from paper or paperboard and a method of imparting oil and grease resistance to paper or paperboard. In each embodiment the paper or paperboard is coated with an aqueous emulsion containing a styrene-(meth)acrylate-resin. The coated paper is used in packaging applications where not only water and oil and grease repellency and/or water vapor transmission barrier are required but food-release properties are necessary. For example, the coating may be applied to the interior of a clamshell package to provide the required food-release property.

For the purposes of the invention, the food-release property is defined as the non-sticking property of the coated paper or paperboard that prevents the sticking of the warm moist foods. The moist food is preferably a bread, bun, pocket bread or food-wrap which when moist and warm has a tendency to stick to paper or paperboard. The bread has a tendency to fragment upon attempts to remove the paper from the bread.

The aqueous emulsions providing the correct properties for OGR and bun-release contain an effective amount of a film-forming polymer prepared by emulsion copolymerizing of a (meth)acrylate monomer or monomers with a vinyl polymerizable monomer or monomers to give the film-forming property. The film-forming polymer is preferably polymerized in the presence of a stabilizing polymer formed from an acid-containing polymer made by copolymerizing (meth)acrylic acid and a vinyl polymerizable monomer other than an acid containing monomer. The emulsion copolymerization of the film-forming polymer in the presence of the stabilizing polymer gives a core-shell particle emulsion. The core comprises the film-forming polymer. The shell comprises the stabilizing polymer. The resulting core-shell particles form a stable aqueous emulsion.

The aqueous emulsions may be used for OGR applications without the addition of fluorochemicals. Surprisingly the emulsion provides high oil and grease repellency when the paper or paperboard is treated with an effective amount of the aqueous emulsion. For example when the emulsion polymer is used in about 20 to about 40 percent solids and preferably at about 30 to about 40 percent solids, effective oil and grease repellency is observed.

This oil and grease repellency may be increased by the addition of a second aqueous solution polymer. For example, copolymers of methacrylate and/or methyl methacrylate with acrylic acid or methacrylic acid may be used to increase the oil and grease repellency. These copolymers are usually for example in the form of a salt which salt may be an alkali or ammonium salt.

The average molecular weight of the second aqueous solution polymer is in the range of about 2,000 to about 30,000, preferably in the range of about 5,000 to about 15,000.

The second aqueous emulsion polymer may be added at about 1 wt. % to about 10 wt. % of the first emulsion polymer but preferably it is added at about 2 wt. % to about 5 wt. % of the first emulsion polymer. This weight percent is based on dry-to-dry weight.

The Film-Forming Polymer

Water based dispersions or emulsion coatings used in paper-based packaging applications ideally are film-forming or in other words provide a continuous pinhole-free polymer film. One useful measure of the film-forming characteristics is the glass transition temperature (Tg) of the constituent polymers, an important measure of the flexibility of the barrier film. In packaging applications the barrier coating needs to be flexible to prevent crease and fold failures.

Another commonly used test for the film-forming characteristics is the “minimum film forming temperature” (MFFT) defined as the minimum temperature at which the dispersed polymer particles coalesce and start to form a continuous film.

The film forming polymer formed from the combination of (meth)acrylate and vinyl monomers are capable of forming a copolymer of glass transition temperature (Tg) below 50° C., preferably below 30° C.

The glass transition temperature (Tg) for a polymer is defined in the Encyclopedia of Chemical Technology, Volume 19, fourth edition, page 891, as the temperature below which (1) the transitional motion of entire molecules and (2) the coiling and uncoiling of 40 to 50 carbon atom segments of chains are both frozen. Thus, below its Tg a polymer would not exhibit flow or rubber elasticity.

The Tg of a polymer may be determined using Differential Scanning Calorimetry (DSC).

The MFFT temperature is determined by ASTM method D2354-98 and is properly applied to the emulsion. Thus the MFFT temperature applies to the coating system and includes other components not just the film-forming copolymer referred to above.

For the purposes of the invention, all styrene based copolymers with alkyl(meth) acrylates giving a Tg of less than 50° C., preferably less than 30° C. could be used as the styrene-acrylate film-forming polymer.

The (meth)acrylate monomers used to form the film-forming polymer are for example selected from the group consisting of n-butyl (meth)acrylate, 2-ethylhexyl (meth)acrylate, hexyl (meth)acrylate, isopropyl (meth) acrylate, decyl or lauryl (meth) acrylate, t-butyl (meth)acrylate, isobutyl(meth)acrylate, ethyl (meth)acrylate, glycidyl (meth) acrylate, hydroxyalkyl (meth) acrylates and dicarboxylic ester monomers such as maleates and propyl (meth)acrylate. The preferred (meth)acrylate monomers are n-butyl (meth) acrylate, 2-ethylhexyl (meth) acrylate and t-butyl (meth) acrylate or mixtures thereof.

The vinyl polymerizable monomer or monomers of the film-forming polymer are selected from the group consisting of methyl (meth)acrylate, isobutyl (meth)acrylate, styrene, and styrene derivatives such as α-methyl styrene, alkylated styrene and mixtures thereof. The preferred vinyl polymerizable monomer or monomers are methyl methacrylate, styrene or alkylated styrene.

The vinyl polymerizable monomer for the film-forming polymer is a monomer such as those described above which do not contain an acid functionality such as (meth)acrylic acid. In particular, styrene, α-methyl styrene and alkylated styrene are preferred.

The weight ratio of the (meth)acrylate monomers to vinyl polymerizable monomers in the film-forming polymer ranges from about 30/70 to about 70/30, preferably the weight ratio of (meth)acrylate monomers to vinyl polymerizable monomers is about 35/60 to about 60/35. Most preferably the weight ratio is about 40/60 to about 60/40 based on the total weight of the film-forming polymer.

For example, the film-forming polymers of the invention include
50 weight % n-butylacrylate and 50 weight % styrene,
45 weight % n-butyl acrylate and 55 weight % styrene,
40 weight % 2-ethylhexyl acrylate and 60 weight % styrene,
40 weight % 2-ethylhexyl acrylate and 30 weight % methyl methacrylate and 30 weight % styrene.
45% weight % 2-ethylhexyl acrylate and 55% weight % styrene.

Each of these examples gives a low Tg (under 50° C.) and are film-forming. For example, a 55/45 styrene 2-ethylhexyl acrylate give a Tg of ˜22° C.

The average molecular weight for the film-forming polymer ranges from about 150,000 to about 350,000 g/mol determined by GPC. Preferably the polymer has a molecular weight of about 200,000 to about 300,000 g/mol. More preferably the optimum molecular weight for the matrix polymer is about 200,000 to about 275,000 g/mol.

In order to obtain an aqueous dispersion from these vinyl monomers, it suffices to perform an emulsion polymerization of the monomers by well-known methods to produce a stable dispersion using hydrophilic catalysts, such as ammonium persulfate, potassium persulfate or aqueous hydrogen peroxide, or redox catalysts.

A mixture of vinyl monomers may be copolymerized in the emulsified state in the presence of anionic or nonionic surfactants to provide an emulsifying agent. In general, the use of low molecular weight surfactants is known to adversely affect the water and water vapor repellency of the coating formed, so that anionic polymeric stabilizers are preferred. These polymeric stabilizing agents may be exemplified by aqueous solutions of conventional alkali-soluble resins, such as acrylic or methacrylic or maleic copolymers containing carboxylic acid groups.

The Stabilizing Polymer

The preferred stabilizing polymer present during the polymerization of the film-forming polymer is made by co-polymerizing (meth)acrylic acid, and a vinyl polymerizable monomer other than an acid monomer to form a copolymer of a glass transition temperature (Tg) that ranges from about 50° C. to about 120° C., preferably from about 70° C. to about 120° C. and most preferably the Tg ranges from about 80° C. to about 110° C.

The vinyl polymerizable monomer or monomers of the stabilizing polymer contain (meth)acrylic acid and a vinyl monomer other than the acid monomer. At least one of the vinyl monomers is preferably selected from the group consisting of styrene, alkylated styrene, α-methyl styrene, butyl (meth)acrylate, methyl (meth)acrylate and mixtures thereof.

The stabilizing polymer is an acid containing polymer made by copolymerizing (meth)acrylic acid, and a vinyl polymerizable monomer other than the (meth)acrylic acid and is formed from about 10 to about 50 weight % acrylic acid, methacrylic acid or mixtures, preferably about 10 to about 45 weight % and about 90 to about 50 weight % of a vinyl polymerizable monomer other than the (meth) acrylic acid monomer, preferably about 90 to about 55 weight %. The monomer percentages are based on total weight of the polymer.

Examples of appropriate stabilizing polymers are
65% styrene and 35 % acrylic acid;
43% isobutyl methacrylate, 43% methyl methacrylate and 14% acrylic acid;
43% butyl acrylate, 43% methyl methacrylate and 14% acrylic acid;
80% ethylene and 20% acrylic acid;

The salts of the stabilizing polymer may be any salt as long as the polymer maintains it's emulsifying properties. Preferably, the polymer is a volatile salt, for example an ammonium salt.

The shell polymer or stabilizing polymer has a molecular weight of about 6,000 to about 15,000 g/mol. Preferably the polymer has a molecular weight of about 6,000 to about 12,000 g/mol. Most preferably, the polymer has a molecular weight of about 6,000 to about 10,000 g/mol.

Generally the average particle size diameter of the particles is less than about 300 nanometers. Preferably the average particle size diameter is in the range of about 200 to 60 nanometers and especially between 150 and 60 nanometers. Average particle size is determined by a Coulter particle size analyzer according to standard procedures well documented in the literature.

A suitable technique for initiating the polymerization is, for instance, to elevate the temperature of the aqueous emulsion of monomer to above about 70 or 80° C. and then to add between 50 and 1000 ppm of ammonium persulfate or an azo compound such as azodiisobutyronitrile by weight of monomer. Alternatively, a suitable peroxide, e.g. a room-temperature curing peroxide, or a photo-initiator may be used. It is preferably that the initiator be water-soluble.

It is preferred that the particles have a core-shell configuration in which the core comprises the film-forming polymer surrounded by a stabilizing polymeric shell. More preferably the particles comprise a core comprising the film-forming polymer and a shell comprising the water-soluble or partially water-soluble stabilizing polymer. It is particularly preferable that the shell of the water-soluble or partially water-soluble polymer is formed around the core of film-forming polymer and during polymerization.

The core-shell polymer is provided in an aqueous emulsion and may include other additives such as thickening agents, defoaming or antifoaming agents, pigments, slip additives, release agents, fluorochemicals, starches, waxes and antiblocking agents. Components such as fluorochemicals, starches and waxes can also be added to improve oil, grease and other barrier properties such as water repellency and water vapor transmission barrier.

The wax component may be selected from the group consisting of paraffin wax, candelilla, carnauba, microcrystalline wax, polyethylene wax and a blend of two or more of said waxes. The combination of the styrene-acrylate emulsion with wax is particularly preferred since when this coating is used on the paper or paperboard, not only does the paper or paperboard provide food-release properties but also helps to maintain the temperature of the food enclosed or wrapped in the paper or paperboard. While not wanting to be limited by any theories, it is believed that the combination of the styrene-acrylate emulsion and wax prevents the water vapor from escaping the package. The retention of the warm vapor within the packaging helps to maintain the temperature of the warm food. The combination of styrene-acrylate emulsion coating with the wax helps maintain the warmth of the food and prevents the warm food from sticking to the paper.

Starches may also be added to the food release coating.

Typical sources of starches include cereals, tubers, roots, legumes and fruits. Native sources can be corn, pea, potato, sweet potato, banana, barley, wheat, rice, sago, amaranth, tapioca, arrowroot, canna, and sorghum.

Useful starches may also include modified versions of any of the aforementioned starches. Modification may be accomplished via physical or chemical substitution on the base starch. Further, more than one type of modification may be used on a single base starch. As used herein, modified starches include, without limitation, crossliniked starches, stabilized starches (i.e., starches which do not undergo retrogradation under freeze-thaw conditions), acetylated and organically esterified starches, hydroxyethylated and hydroxypropylated starches, phosphorylated and inorganically esterified starches, cationic, anionic, nonionic, and zwitterionic starches, and succinate and substituted succinate derivatives of starch. Such modifications and combinations thereof are known and their preparation are described in the art. See, for example, Whistler, R. L., BeMiller, J. N. and Paschall E. F., STARCH CHEMISTRY AND TECHNOLOGY, 2.sup.nd Ed., Academic Press, Inc., London, Chpt. 9, sctn. 3, pp. 324-349 (1984) and MODIFIED STARCHES: PROPERTIES AND USES, Wurzburg, O. B., Editor, CRC Press, Inc., Florida (1986).

The amount of starch used in the food-release coating normally ranges from 0% to 10% by weight of the total coating formulation. The preferred starches are hydroxyalkylate corn starches such as hydroxyethylated and hydroxypropylated corn starches.

Examples of likely ethoxylated corn starches available commercially are Coatmaster K56F, from Grain Processing Corp. (Muscatin, Iowa), Ethylex 2075 from A. E. Staley Mfg. (Decatur, Ill.), Filmkote 85:54 from National Starch and Chemicals (Bridgewater, N.J.), Penford Gum 270 from Penfort Products Co. (Cedar Rapids Iowa). An example of likely ethoxylated potato starch is Solfarex A-55 supplied by Avebe America Inc.

The use of perfluoroalkyl-substituted compounds to impart oil and grease repellency to paper substrates is well known in the art. For paper treatment the most important products have traditionally been phosphate diesters of a perfluoroalkylalkanol or diperfluoroalkyl-substituted carboxylic acids, as described in U.S. Pat. Nos. 4,485,251, 4,898,981, 5,491,261 and 6,436,235 herein incorporated by reference. These compounds are applied by rollers, a size press or other means to the finished paper as a coating. Copolymers of poly-perfluoroalkyl (meth)acrylates may also be used as external paper sizes since polymers provide the extra benefit of water resistance which is a desirable feature in many food packaging and fast-food applications.

U.S. Pat. No. 3,083,224 also incorporated by reference discloses certain polyfluoroalkyl phosphates, which are also useful in imparting oil repellency to paper and textile materials.

The amount of perfluorinated compounds used in the coating composition ranges from 0% to about 1% by weight based on the dry weight of the coating. The effectiveness of the perfluorinated compound for OGR performance will depend upon the total amount of fluorine incorporated into the coating. Preferably the range of the perfluorinated compound varies from 0% to 0.3% based on the dry weight of the coatings.

The formed coating emulsion or food release coating composition including the core-shell polymer, and additives is generally anywhere from about 30 to about 60 % solids based on the total weight of the emulsion. Preferably the solids range from about 40 to about 50 % solids based on the total weight of the emulsion.

The weight ratio of the film-forming polymer and the stabilizing polymer in the emulsion range from about 40 to 80 weight % film-forming and about 60 to 20 weight % stabilizing polymer; preferably the film-forming polymer and stabilizing polymer range from about 50 to about 80 weight % film-forming and about 50 to about 20 weight % stabilizing polymer based on the total weight of the film-forming and stabilizing polymer.

Substrates employed in the invention include a variety of coated and uncoated paper and paperboard, including bleached or unbleached, hardwood or softwood, virgin or recycled, coated or uncoated forms of paper or paperboard. The basis weight of the substrate ranges from 20 to 450 g/m². Preferable range of basis weight is about 35 to about 70 g/m².

The water based emulsion coatings of the invention have dry coating weights in the range of about 1 to about 10 g/m². Drying temperatures and line speeds are dictated by the drying characteristics of specific coating formulations, for example the % solids content, substrate basis weight and adsorbency, and equipment characteristics. For example for hot, moist food applications where bun release properties are needed, the coating weights will generally range from about 1 to about 5 g/m² and preferably about 1 to about 3 g/m² if fluorochemicals are added.

When the polymer emulsion is used for OGR applications, an effective coating weights will generally range from about 2 to about 9 g/m² and preferably about 2 to about 6 g/m². For example, a coating weight of about 2 g/m² or greater is needed to obtain effective oil and grease repellency.

The base paper of OGR applications preferably has a basis weight of at least about 30 g/m2. Preferably the paper has a Parker Print Surf Smoothness below about 4 micrometers (μm). Preferably the Gurley Porosity is >10 seconds and most preferably equal to or greater than 100.

The Parker Print Surf Smoothness and Gurley Porosity are well known in the art and may be determined using TAPPI methods T-555 om-99 and T-536 om-96 respectively.

Effective oil and grease repellency for the purposes of the invention is a value of one-half hour for the Turpentine test (see TAPPI T454 om-94 below) or a value of less than about 5 % according to the RALSTON-PURINA test (see RP-2 below).

The RP2 Test is a pet food test. Pet food is far more oil aggressive than human food and so a treated substrate that works well for RP2 test will work well of human food.

The water-based emulsion coatings of this invention may be applied to the surface of the substrate by any method of coating suitable for water-based coatings. Examples of suitable surface treatment methods include various conventional coating methods such as air knife coating, blade coating, metering roll coating, rod coating, curtain coating, spray coating, injet printing, flexo and gravure coating, size press applications and water box.

Generally some type of elevated temperature drying will be required in order to dry the water based emulsion coatings at an acceptable production speed. Suitable drying methods include hot air drying, infrared drying, direct flame drying and drying by contact with a steam roll.

The example below illustrates the invention and is not meant to limit the scope and spirit of the invention in any way.

Formation of the Core Shell Polymer

EXAMPLE 1

| Monomer Feed | | |
|---|---|---|
| Styrene | 1294 | g |
| 2-ethylhexyl acrylate | 1058 | g |
| Reactor Charge | | |
| 65/35 styrene/acrylic acid | 988 | g |
| copolymer as ammonium salt | | |
| Water | 3497 | g |
| ¹TETRALON B | 1.5 | g |
| Reactor initial Initiator charge | | |
| Water | 23 | g |
| Ammonium Persulphate | 3.4 | g |
| Initiator Feed | 210 | g |
| Water | | |
| Ammonium Persulphate | 9 | g |
| Monomer Feed line flush | | |
| Water | 50 | g |
| Post additions | | |
| ²ACTICIDE LG | 7 | g |
| Water | 130 | g |

The monomer feed is added to the reactor over 3 hours and initiator feed is added over 4 hours. The reactor is maintained at 85° C. throughout polymerization.

A styrene/2-ethylhexyl acrylate film-forming copolymer is formed in the presence of the stabilizing 65/35 styrene/acrylic acid polymer and results in a core-shell polymer that is approximately a 46% solids emulsion. The composition of the particles is 70 parts styrene/2-ethylhexyl acrylate copolymer (55/45) core and 30 parts (65/35) styrene/acrylic acid shell. The particle size of the core-shell is typically about 80 nm to about 120 nm.
1. TETRALON B is a sequestering agent.
2. ACTICIDE LG is a biocide.
   Application Testing

The bun-release and oil kit below are preformed using the 46% solids emulsion of example 1. Various formulations using the emulsion are listed below in table 1. All numbers are based on weight % of the total emulsion unless otherwise specified.

TABLE 1

| | Application Testing No. | | | | | | | | | | |
|---|---|---|---|---|---|---|---|---|---|---|---|
| | 1 | 2 | 3 | 4 | 5 | 6 | 7 | 8 | 9 | 10 | 11 |
| Example 1 | 15 | 10 | 10 | 10 | 7.5 | 7.5 | 0 | 0 | 25 | 20 | 15 |
| ¹Starch | 5 | 5 | 6.5 | 6.5 | 7.5 | 7.5 | 7.5 | 7.5 | 0 | 0 | 0 |
| ²LODYNE 2000 | 0 | 0 | 0 | 0.125 | 0 | 0.125 | 0 | 0.25 | 0 | 0 | 0 |
| Total wt. % solids | 20 | 15 | 16.5 | 16.625 | 15 | 15.125 | 7.5 | 7.75 | 25 | 20 | 15 |
| Total Solid Coat wt. (g/m2) | 2.11 | 1.50 | 1.85 | 1.95 | 1.49 | 1.52 | 0.88 | 0.81 | 2.41 | 1.94 | 1.43 |
| ³Dry Coat wt. of core-shell polymer (g/m2) | 1.58 | 1.00 | 1.12 | 1.18 | 0.74 | 0.75 | 0.00 | 0.00 | 2.41 | 1.94 | 1.43 |

¹Hydroxy ethoxylated corn starch supplied as COATMASTER K56F, from Grain Processing Corp. (Muscatin, Iowa).
²Fluorinated amphoteric organic acid ammonia salt. Supplied by Ciba Specialty Chemical Corp, Tarrytown, NY.
³The dry coating weight is based on the 46% solids emulsion formed in example 1 after drying.

Bun Release Test

Sheets of 50 g/m² basis weight paper are size press coated in the lab with the formulations above and placed on the interior bottom of McDonald's clamshells. Pairs of McDonald's hamburger buns, crowns and heels, were steamed in a steam chamber for two minutes, and a pair of bun crown and heel is then placed upside down in the clamshell in direct contact with the treated side of the paper sample. A 50 ml beaker with 65 g of sand (to simulate the weight of an assembled hamburger) is placed on top of the bun and the clamshell is closed and placed into a heating chamber at 180° F. for two minutes. The clamshell is removed from the heating chamber and the bun crown is gently pulled from the test paper. The ratings go from 1 indicating no sticking, to very slight sticking up to a rating of 7 which represents tearing of the moist bun.

Oil Kit Test

The oil repellency of the surface is determined by using the TAPPI UM 557 OIL KIT TEST, which consists of determining which of twelve castor oil-heptane-toluene mixtures having decreasing surface tension penetration occurs within 15 seconds; ratings go from 1, lowest, up to 12.

TABLE 2

| | Application Testing No. | | | | | | | | | | |
|---|---|---|---|---|---|---|---|---|---|---|---|
| | 1 | 2 | 3 | 4 | 5 | 6 | 7 | 8 | 9 | 10 | 11 |
| Oil kit | 4 | 1 | 2-3 | 3 | 1 | 1-2 | 0 | 8 | 4 | 3 | 2 |
| Bun | 1 | 2 | 1 | 1 | 7 | 1 | 7 | 4 | 1 | 1 | 1 |
| Release | | | | | | | | | | | |
| Ratings | | | | | | | | | | | |

Oil and Grease Repellency (OGR) Testing of Paper Coatings

Coatings for the OGR testing are made up at 30 and 40 percent solids based on total weight from the emulsion formed in example 1. Examples 13-15 are formulated with an additional 4 percent second solution polymer solids (dry-to-dry in relation to the emulsion of example 1). The coatings are applied by a filmpress applicator. Drying is carried out by hot air or IR at coating speeds of approximately 100 meters/min. The rod pressures are adjusted to obtain different coat weights. The coating weights are determined gravimetrically.

The base paper is 38 gsm (grams/m²) for candy-wrap applications.

Oil and Grease Resistance Tests

RALSTON-PURINA (RP2) Test

Grease resistance is determined with the RALSTON-PURINA test for pet food materials; RP-2 Test, Ralston-Purina Company, Packaging Reference Manual Volume 06, Test Methods. In summary: cross-wise creased and uncreased test papers are placed over a grid sheet imprinted with 100 squares. For the crease test five grams of sand are placed in the center of the crease. A mixture of synthetic oil and a dye for visualization is pipetted onto the sand and the samples are maintained at 60° C. for 24 hours. Ratings are determined by the percentage of stained grid segments, using at least two samples. The uncreased test is identical to the creased but the paper is not creased.

Turpentine Test

According to TAPPI T454 om-94, a preliminary test to determine rates at which oil or grease can be expected to penetrate the paper. Table 2 below presents a summary of these results.

TABLE 2
Grease and Oil Repellency Resulta

| | | | | RP-2 | | | |
|---|---|---|---|---|---|---|---|
| | | | Turpentine | Uncreased | Uncreased | Creased | Creased |
| | Wt % | Coat wt. | Test | 1 | 2 | 1 | 2 |
| EX | Solids | [g/m²] | [hr] | [%] | [%] | [%] | [%] |
| 2 | 40% | 3 | 2.50 | 1.1 | 1.4 | 1.9 | 7.4 |
| 3 | 40% | 4.5 | 6.00 | 3.3 | 0.3 | 4.1 | 2.2 |
| 5 | 40% | 4 | 6.00 | 0.4 | 1.1 | 5.3 | 6.7 |
| 6 | 40% | 5 | 24.00 | 9.0 | 3.2 | 48.2 | 3.1 |
| 7 | 30% | 1.5 | 0.50 | 1.6 | 1.9 | 5.3 | 6.7 |
| 8 | 30% | 2 | 1.00 | 2.1 | 2.4 | 14.2 | 9.9 |
| 9 | 30% | 2.5 | 1.50 | 1.4 | 5.6 | 100.0 | 13.5 |
| 10 | 30% | 1 | 0.50 | 1.6 | 2.0 | 7.4 | 4.3 |
| 11 | 30% | 2 | 0.50 | 0.8 | 4.7 | 16.7 | 4.2 |
| 12 | 30% | 3 | 4.00 | 0.7 | 3.1 | 6.7 | 7.1 |
| 13 | 40%+¹ | 3 | 0.05 | 0.1 | 48.0 | 4.8 | 9.1 |
| 14 | 40%+ | 4 | 1.50 | 0.1 | 0.1 | 3.3 | 3.4 |
| 15 | 40%+ | 6 | 24.00 | 0.1 | 0.3 | 8.7 | 4.2 |
| 16 | | 0 | 0.00 | 100.0 | 100.0 | | |

¹The coatings for examples 13-15 also include 4% based on dry weight to total coating weight of an aqueous solution copolymer of methyl acrylate/methylmethacrylate/acrylic acid, 65/25/10 ammonium salt.

We claim:

1. A hot-moist food packaging,
wherein the packaging is a paper or paperboard coated with a coating composition and the coating comprises a
water based emulsion polymer, wherein the polymer comprises
i.) a copolymer formed from a (meth)acrylate monomer or monomers and a vinyl monomer or monomers to give a film-forming copolymer,
wherein the film-forming polymer is formed in the presence of a stabilizing polymer,
wherein the stabilizing polymer is an acid-containing copolymer formed by copolymerizing a (meth)acrylic acid monomer or a mixture of (meth)acrylic acid monomers, and a vinyl monomer or mixture of vinyl monomers other than the (meth) acrylic acid monomer,
and
ii.) optionally, other additives or mixtures of additives,
wherein, the coated paper or paperboard has a bun-release rating of no more than about 3.

2. A coating composition according to claim 1, wherein the other additives or mixture of additives are selected from the group consisting of thickening agents, defoaming or antifoaming agents, pigments, slip additives, release agents, fluorochemicals, starches, waxes and antiblocking agents.

3. A coating composition according to claim 2, wherein the fluorochemical is
selected from the group consisting of phosphate diesters of a perfluoroalkylalkanol, di-perfluoroalkyl-substituted carboxylic acids, amphoteric perfluoroakyl-substituted carboxylic acids, and copolymers of poly-perfluoroalkyl (meth)acrylates.

4. A coating composition according to claim 2, wherein the starch is selected from the group consisting of crosslinked starches, stabilized starches, acetylated or organically esterified starches, hydroxyethylated or hydroxypropylated starches, phosphorylated or inorganically esterified starches, cationic, anionic, nonionic, zwitterionic starches, and succinate or substituted succinate starches.

5. A coating composition according to claim 1, wherein the film-forming (meth) acrylate monomer or monomers are selected from the group consisting of n-butyl (meth)acrylate, 2-ethylhexyl (meth)acrylate, hexyl (meth)acrylate, isopropyl (meth) acrylate, decyl or lauryl (meth) acrylate, t-butyl (meth)acrylate, isobutyl(meth)acrylate, ethyl (meth)acrylate, glycidyl (meth) acrylate, hydroxyalkyl (meth) acrylates, dicarboxylic ester monomers and propyl (meth)acrylate.

6. A coating composition according to claim 1, wherein the film-forming vinyl monomer or monomers are selected from the group consisting of methyl (meth)acrylate, isobutyl (meth)acrylate, styrene, α-methyl styrene, alkylated styrene and mixtures thereof.

7. A coating composition according to claim 1, wherein the coating composition has a minimum film-forming temperature of not greater than about 25° C.

8. A coating composition according to claim 1, wherein the film-forming copolymer has a glass transition temperature less than about 50° C.

9. A coating composition according to claim 1, wherein the hot moist food is selected from the group consisting of bread, buns, wraps, sandwiches, fried potatoes and pocket breads.

10. A method for packaging hot moist foods comprising the steps of
a) coating a paper or paperboard container or wrapper with a coating composition comprising
a water based emulsion polymer comprising
i) a copolymer formed from a (meth)acrylate monomer or monomers and a vinyl monomer or monomers to give a film-forming copolymer,
and
ii) optionally, other additives or mixtures of additives,
b) drying the coating
and
c) contacting the hot moist food with the coated paper or paperboard container or wrapper,
wherein the food may be heated in the paper or paperboard or alternatively, the food may be heated then wrapped.

10. A method according to claim 9, wherein the (meth) acrylate monomer or monomers are selected from the group consisting of n-butyl (meth)acrylate, 2-ethylhexyl (meth)acrylate, hexyl (meth)acrylate, isopropyl (meth) acrylate, decyl or lauryl (meth) acrylate, t-butyl (meth)acrylate, isobutyl(meth)acrylate, ethyl (meth)acrylate, glycidyl (meth) acrylate, hydroxyalkyl (meth) acrylates, dicarboxylic ester monomers and propyl (meth)acrylate.

11. A method according to claim 10, wherein the (meth)acrylate monomer or monomers are selected from the group consisting of n-butyl (meth) acrylate, 2-ethylhexyl (meth) acrylate and t-butyl (meth) acrylate or mixtures thereof.

12. A method according to claim 9, wherein the vinyl monomer or monomers of the film-forming copolymer is selected from the group consisting of methyl (meth)acrylate, isobutyl (meth)acrylate, styrene, α-methyl styrene, alkylated styrene and mixtures thereof.

13. A method according to claim 9, wherein the other additives or mixture of additives are selected from the group consisting of thickening agents, defoaming or antifoaming agents, pigments, slip additives, release agents, fluorochemicals, starches, waxes and antiblocking agents.

14. A method according to claim 13, wherein the additives or mixture of additives are selected from the group consisting of fluorochemicals, starches, waxes and mixtures thereof.

15. A method according to claim 14, wherein the fluorochemical is selected from the group consisting of phosphate diesters of a perfluoroalkylalkanol, di-perfluoroalkyl-substituted carboxylic acids, amphoteric perfluoroakyl-substituted carboxylic acids, and copolymers of poly-perfluoroalkyl (meth)acrylates.

16. A method according to claim 14, wherein the starch is a modified starch selected from the group consisting of crosslinked starches, stabilized starches, acetylated or organically esterified starches, hydroxyethylated or hydroxypropylated starches, phosphorylated or inorganically esterified starches, cationic, anionic, nonionic, zwitterionic starches, and succinate or substituted succinate starches.

17. A method according to claim 14, wherein the wax is selected from the group consisting of paraffin wax, candelilla, carnauba, microcrystalline wax, polyethylene wax or a blend of two or more of said waxes.

18. A method according to claim 9, wherein the coating composition has a minimum film forming temperature of about not more than 25° C.

19. A method according to claim 9, wherein the coated paper has a bun-release rating of equal to or less than about 3.

20. A method according to claim 9, wherein the hot moist food is selected from the group consisting of bread, buns, wraps, sandwiches, french fries and pocket breads.

21. A method according to claim 9, wherein the film-forming polymer is polymerized in the presence of a stabilizing polymer, wherein the stabilizing polymer is an acid-containing copolymer formed by copolymerizing a (meth)acrylic acid monomer or a mixture of (meth)acrylic acid monomers, and a vinyl monomer or mixture of vinyl monomers other than the (meth) acrylic acid monomer.

22. A method according to claim 9, wherein at least one of the vinyl monomers is selected from the group consisting of styrene, alkylated styrene, α-methyl styrene, butyl (meth)acrylate, methyl (meth)acrylate and mixtures thereof.

23. A method according to claim 21, wherein the stabilizing polymer has a Tg of from about 70° C. to about 120° C.

24. A method of releasing hot moist food from the surface of paper or paperboard, wherein the method of releasing the hot moist food comprises the steps of
a) coating a paper or paper-board with a composition comprising
a water based emulsion polymer, wherein the polymer comprises
i) a copolymer formed from a (meth)acrylate monomer or monomers and a vinyl monomer or monomers to give a film-forming copolymer,
and
ii) optionally, other additives or mixtures of additives,
b) drying the coating,
c) contacting the coated paper or paperboard with the food
and
d) removing the coated paper from contact with said food.

25. A method according to claim 24, wherein the coating composition further comprises a fluorochemical selected from the group consisting of phosphatediesters of a perfluoroalkylalkanol, di-perfluoroalkyl-substituted carboxylic acids, amphoteric perfluroalkyl-substituted carboxylic acids and copolymers of poly-perfluoroalkyl (meth)acrylates.

26. A method for packaging hot moist foods and maintaining the temperature of these food items during delivery wherein the method of packaging and maintaining the temperature of the food comprises the steps of
a) coating a paper or paperboard with a coating composition comprising
a water based emulsion polymer comprising
i.) a copolymer formed from a (meth)acrylate monomer or monomers and vinyl monomer or monomers to give a film-forming copolymer,
and
ii.) optionally, other additives or mixtures of additives,
b) drying the coating
and
c) wrapping or enclosing the hot moist food with the coated paper or paperboard container or wrapper, wherein the food may be heated in the coated paper or paperboard or alternatively the food may be heated then wrapped in the coated paper or paperboard.

27. A method according to claim 22, wherein the water based emulsion polymer additionally comprises a wax selected from the group consisting of paraffin wax, candelilla, carnauba, microcrystalline wax, polyethylene wax or a blend of two or more of said waxes.

28. A method according to claim 26, wherein the water based emulsion polymer additionally comprises a wax selected from the group consisting of paraffin wax, candelilla, carnauba, microcrystalline wax, polyethylene wax or a blend of two or more of said waxes and the coated paper or paperboard has a bun-release rating of no more than about 3.

29. A method of imparting oil and grease resistance to paper or paperboard, which comprises treating the paper or paperboard material with an effective amount of a coating composition comprising a
water based emulsion polymer, wherein the polymer comprises
j) a copolymer formed from a (meth)acrylate monomer or monomers and a vinyl monomer or monomers to give a film-forming copolymer,
wherein the film-forming polymer is formed in the presence of an stabilizing polymer, wherein the stabilizing polymer is an acid-containing copolymer formed by copolymerizing a (meth)acrylic acid monomer or a mixture of (meth)acrylic acid monomers, and a vinyl monomer or mixture of vinyl monomers other than the (meth) acrylic acid monomer,
and
ii) optionally, other additives or mixtures of additives.

30. A method according to claim 29 wherein the emulsion polymer is in the form of a core-shell particle emulsion.

31. A clamshell package coated with a composition according to claim 1.
